(19) United States
(12) Patent Application Publication
(10) Pub. No.: US 2024/0009891 A1
(43) Pub. Date: Jan. 11, 2024

(54) METHOD FOR PRODUCING A POLYMER MATERIAL LOADED WITH RECYLCED TEXTILE FIBRES

(71) Applicant: Plaxtil, Chatellerault (FR)

(72) Inventors: Jean-Marc Neveu, Saint Benoit (FR); Olivier Civil, Toulouse (FR)

(21) Appl. No.: 18/253,480

(22) PCT Filed: Nov. 26, 2021
(86) PCT No.: PCT/FR2021/052098

§ 371 Date: May 18, 2023

(30) Foreign Application Priority Data
Nov. 27, 2020 (FR) 2012281

(51) Int. Cl. B29B 7/90; B29B 9/06; B29B 7/00

(52) U.S. Cl. CPC B29B 7/90; B29B 9/06; B29B 7/007; B29K 2067/046

(57) ABSTRACT

A method for producing a composite material in the form of pellets from ground textile fibers and polymer in the form of resin grains comprises the steps of: a. densification of shreds of the textile fibers by compressing the material; b. mixing the densified shreds with the polymer; and c. mechanical treatment at a temperature between the temperatures T₁ and T₂ wherein T₁ is the highest glass transition temperature between the polymer and that of the textile, whichever applies, and T₂ is the lowest melting point chosen between that of the polymer and that of the textile, whichever applies. The heat treatment is implemented by extrusion and/or injection. A composite material, referred to as PLAXTIL® composite material, may be formed using this method.

### CROSS-REFERENCE TO RELATED APPLICATIONS

This application is a national phase entry under 35 U.S.C. § 371 of International Patent Application PCT/FR2021/052098, filed Nov. 26, 2021, designating the United States of America, and published as International Patent Publication WO 2022/112719 A1 on Jun. 2, 2022, which claims the benefit under Article 8 of the Patent Cooperation Treaty to French Patent Application Serial No. FR2012281, filed Nov. 27, 2020.

### TECHNICAL FIELD

The present disclosure relates to the field of recycled materials. More particularly, the present disclosure relates to a method for preparing a composite material loaded with textile fibers making it possible to integrate recycled textile fibers regardless of their nature.

The present disclosure also relates to the resulting PLAXTIL® composite material.

### BACKGROUND

The fashion industry is considered the second-most-polluting industry, after the oil industry. A very active sector whose CO2 emissions are higher than that of air and oil transport combined.

Faced with the environmental consequences of this sector, textile recycling channels are growing and have been focused for several years on collecting and sorting textiles. However, to date, only a minimal portion of the textiles is effectively recycled. This shortfall is partly due to the heterogeneity of textile fibers, which makes large-scale recycling complex.

The methods of the prior art are generally adapted to particular types of textile fibers and the methods are quite complex. By way of example, mention may be made of patent FR2998572, which describes a method for recycling the constituents of a textile product, optionally comprising a pretreatment of the textile product to be recycled and at least the following steps: (i) hydrolysis of the animal fibers, (ii) hydrolysis of the cellulosic fibers, (iii) glycolysis of the polyester fibers. The hydrolysis steps carried out in parallel each give rise to the production of a cake, the different residual textile cakes being mixed and the mixture extruded to produce a recycled plastic material. Another example, US 2020/0262108, which describes a method for recycling a mixed cotton-polyester textile, comprising hydrolyzing the textile in an aqueous solution containing an organic acid catalyst and heated to 110-180° C. in a high-pressure reactor so as to separate the cotton fibers from the polyester and ultimately recover the cotton fibers by means of a vacuum filtration membrane.

Document US 2015/175763 describes a method for preparing a composite material from natural fibers comprising, in particular, a pre-treatment step of heating the ground fibers ([0013]), mixing the fibers with a polymer, a nitrogen-swelling agent, and a lubricant ([0014]), and a step of heating the mixture to the melting point of the polymer ([0015]). The fibers comprise mainly of rice fibers. The objective is to produce a construction material that is low-density thanks to the presence of a blowing agent ([0097]). This material contains, due to the addition of the blowing agent, randomly distributed bubbles. It is therefore a material with a heterogeneous and porous structure whose mechanical strength properties are degraded. Furthermore, given the various components used, this material is not recyclable.

None of these processes allows a treatment of the entire textile; rather, it requires specific treatment adapted to the nature of the textile to be recycled. The choice of “specialized” treatment is explained by, in particular, the difficulty in mixing and homogenizing two materials whose densities differ significantly, in particular, in the case of shredded textile fibers and a polymer. There are added to this difficulty differences in transition temperatures and melting points that make certain fiber/polymer combinations incompatible.

To date, there is no method for the recycling of entire textiles comprising different types of textile fibers of different densities.

It would be useful to have a method for recycling textile fibers regardless of their nature.

### BRIEF SUMMARY

A novel method has been developed for recycling textiles made of composite material that makes it possible to treat all types of textiles. The present disclosure thus provides a new composite material obtained from recycled textile materials.

This method for manufacturing a composite material in the form of pellets from ground textile fibers and polymer in the form of resin grains comprises the steps of:
a. Densification of the textile shreds by compressing the material;
b. Mixing the densified shreds with the polymer; and
c. Mechanical treatment at a temperature between the temperatures T₁ and T₂;
   T₁ being the highest glass transition temperature between the polymer and that of the textile, whichever applies; and
   T₂ being the lowest melting point chosen between that of the polymer and that of the textile, whichever applies;
the heat treatment being implemented by extrusion and/or injection.

The present disclosure also relates to a PLAXTIL® composite material based on recycled textile fibers obtained by the method according to the present disclosure.

The method according to the present disclosure has the major advantage of allowing the treatment of any type of textile, including fiber blends, in order to recycle the textile into a composite material with interesting properties.

The method makes it possible to treat any type of textile fibers, regardless of its nature, natural or synthetic, and regardless of its density. It is not necessary to know the nature of the fibers, in particular, when they are blends, to treat the textile by the method of the present disclosure, which removes a major obstacle compared with the current recycling methods. The resulting composite material has very good mechanical qualities due to a good fiber/matrix affinity, which can be used in plastic applications.

Thanks to its versatility, this method of the present disclosure makes it possible to produce an extended range of materials having very diverse mechanical, aesthetic and ecological characteristics, depending on the types of textiles and resins used. It is thus possible to meet the various expectations of manufacturers regardless of their needs in terms of appearance, resistance or ecological characteristics. The material may be 100% natural and biodegradable when it is prepared from natural textile fibers and PLA.

The life cycle of composite materials addresses a long-term recycling logic: firstly because the materials are preferably produced from used waste textile materials (waste), but also because the composite material itself can be recycled in a closed loop with no limit on the number of cycles.

The resulting composite material is considered an ecological plastic. It is infinitely recyclable and can replace 100% petroleum plastic materials. This is a credible alternative for industry in general and for the fashion industry, in particular. Indeed, the material may be shaped in the form of fibers usable in the textile industry, while remaining recyclable subsequently. Thus, the method is part of the circular sustainable economy.

### DESCRIPTION OF THE DRAWINGS

FIG. 1 is a graph showing the resiliency of polypropylene (PP) blends with different percentages of recycled cotton textile fibers (RCTF).

FIG. 2 is a graph showing the resiliency of PP blends with different percentages of recycled blended textile fibers (RBTF).

FIG. 3 is a graph showing the resiliency of PP blends with recycled synthetic textile fibers (RSTF).

FIG. 4 is a graph showing the resiliency of polylactic acid (PLA) blends with different percentages of RCTF.

FIG. 5 is a graph showing the resiliency of PLA blends with different percentages of RSTF.

FIG. 6 is a graph showing the resiliency of PLA blends with different percentages of RBTF.

FIG. 7 is a graph showing the resiliency of polyester (PET) blends with different percentages of RCTF.

FIG. 8 is a graph showing the resiliency of PET blends with different percentages of RSTF.

FIG. 9 is a representation of the products obtained at the different steps of the method, here obtained from recycled surgical masks. A: starting shredded textile, B: densified shredded textile in pellet form; C: compound obtained after extrusion.

### DETAILED DESCRIPTION

A first object of the present disclosure relates to a method for manufacturing a composite material in the form of pellets from ground textile fibers and polymer in the form of resin grains comprises the steps of:
a. Densification of the textile shreds by compressing the material;
b. Mixing the densified shreds with the polymer; and
c. Mechanical treatment at a temperature between the temperatures T₁ and T₂;
   T₁ being the highest glass transition temperature between the polymer and that of the textile, whichever applies; and
   T₂ being the lowest melting point chosen between that of the polymer and that of the textile, whichever applies;
the heat treatment being implemented by extrusion and/or injection.

Obtaining a composite material of good quality depends on the “quality” of the materials in its composition. The inventors have demonstrated the importance of the density parameter of the shredded textile fibers in this method and proposes densifying the shredded textile fibers before mixing them with the polymer for melting. Densification allows the textile to be properly measured with a view to mixing it with the polymer and facilitates the textile-polymer blend. Typically, the shredded textile is compacted until a density at least 10 times greater than that of the starting shredded textile is obtained. In a preferred embodiment, the densified shredded material is in the form of a solid but brittle pellet. The pellet obtained after densification is shown in FIG. 9B, in comparison with the non-densified milled shredded material presented in FIG. 9A.

This densification step is preferably carried out in a press, for example, an agricultural press intended for the preparation of wood pellets for heating.

In a preferred embodiment of the present disclosure, corn starch powder is added to the textile fibers before the densification step. The amount of starch powder represents up to 2% of the amount of textile material, generally between 1 and 2% (by weight). This powder provides fluidity to the textile material. This makes it possible to improve the mutual cohesion of the fibers and thus facilitates the mixing with the polymer and their melting so that the resulting composite material is homogeneous.

After densification, the textile fibers are mixed with the polymer grains.

When the composite material is implemented by injection, the injection step comprises either a single injection, or two successive injections separated by a grinding step.

Preferably, the heat treatment for shaping the pellets is carried out by extrusion. This extrusion makes it possible to carry out compounding; compounding involves extruding very fine pellets from blends of thermoplastic materials. The compound obtained after extrusion is shown in FIG. 9C. In the form of a compound, the composite material is compatible with all presses used for injectable products and can therefore be used by manufacturers just like any plastic material.

The textile fibers may be of any nature. They may be woven or non-woven textile. The fibers may be natural fibers such as cotton, linen, hemp, evening, etc., alone or as a blend, or they may synthetic fibers manufactured by polymerization of an oil derivative such as polypropylene (PP), polyester (PET), acrylic (PAN), polyvinyl chloride (PVC), etc., alone or as a blend, or they may be mixed fibers.

Preferably, textile shreds before densification have a size of about 5 mm.

Preferably, the polymer is polylactic acid (PLA), polypropylene (PP) or high-density polyethylene (HDPE), the choice being oriented according to the type of the majority of the textile fibers.

The percentage of textile fibers that can be integrated into the material depends on the type of fibers and the type of polymer, but is generally between 1% and 90%. It will preferably be between 15% and 50%.

When the textile fibers of the composite material are exclusively natural fibers, they may represent up to 50% by weight of the composite, more generally up to 40% of materials.

When the textile fibers of the composite material are exclusively synthetic fibers, they represent up to 90% by weight of the composite.

When the textile fibers of the composite material are mixed fibers, they represent up to 70% by weight of the composite.

“Mixed fibers” means fibers obtained by mixing natural and synthetic materials. It is not necessary to know the nature of the mixture, the method will operate technically with any textile mixture. Preferably, the mixed textile fibers are combined with a petroleum polymer matrix.

To obtain a material having interesting properties, it is necessary to cause partial melting of the fibers during extrusion. However, the glass transition temperatures and melting points of the textile fibers and of the polymers are not necessarily compatible. If during the heat treatment step the temperature is too low, the fibers do not merge and if it is too high, they are degraded. This is why the heat treatment must be implemented at a temperature between the temperatures T₁ and T₂:
T₁ being the highest glass transition temperature between the polymer and that of the textile, whichever applies; and
T₂ being the lowest melting point chosen between that of the polymer and that of the textile, whichever applies

By way of example, the glass transition temperature of PLA is around 60° C., while its melting point is around 175° C. on the other hand, the cotton browning around 150° C. and decomposes around 200° C. (no glass transition temperature, nor any melting point is defined for the natural materials; it is necessary just to ensure that the natural fibers are not degraded by too high a temperature). Thus, in this example, the optimal heat treatment temperature is between 150° C. and 175° C. Furthermore, the press time influences the melting of the materials. Those skilled in the art know how to adapt these temperature/pressure parameters as a function of the desired result.

In the context of the present disclosure, the preferred polymers are polylactic acid (PLA), polypropylene (PP) and high-density polyethylene (HDPE) because they have glass transition temperatures and melting temperatures compatible with those of textile fibers and constitute matrices suitable for obtaining a composite material with interesting properties. Other types of polymer may be used.

In preferred embodiments of the present disclosure where the mechanical properties are particularly advantageous:
the textile fibers are natural fibers, the polymer used is PLA.
the textile fibers are synthetic fibers, the polymer used is PP or HDPE.

In one entirely preferred embodiment, the natural fibers are made of cotton and the polymer is PLA. This embodiment encompasses the case where the fibers are predominantly made of cotton, namely that at least 50% of the material is cotton. Very preferably, the fibers are 100% cotton and the polymer is PLA; this material being 100% natural and biodegradable.

A particular application of the method according to the present disclosure involves recycling surgical disposable masks, used in large amounts during pandemics such as the one linked to Covid-19. In this case, the textile is decontaminated before being treated.

A second object of the present disclosure relates to a composite material based on recycled textile fibers obtained by the method as defined above. This material is known as PLAXTIL®.

In a first particular embodiment, the composite material exclusively comprises natural fibers, which represent up to 50% of the material, and PLA. In a preferred embodiment, the composite material comprises 100% natural fibers, for example, cotton fibers, and PLA.

In a second particular embodiment, the composite material exclusively comprises synthetic fibers, which represent up to 90% of the material, and PP or HDPE.

In a third particular embodiment, the composite material comprises a mixture of synthetic fibers and natural fibers; this mixture of fibers represents up to 70% of the material. In this case, the polymer is preferentially of petrochemical origin, it is for example, PP or HDPE.

The composite material in the form of pellets may be injected in different forms, in particular, in the form of fibers that can be used in the textile industry.

All the composite materials according to the present disclosure are recyclable. This interesting property is directly related to the fact that the method does not induce any structural modification in either the fibers or the polymer. In particular, no chemical agent capable of inducing such a modification of the material is used. Likewise, the temperatures and forces applied during the method do not cause any change of state. The resulting composite material typically has a thermoplastic material behavior.

The present disclosure will be better understood upon reading the examples that follow, provided by way of illustration, and in no way considered to be limiting on the scope of the present disclosure.

### EXAMPLES

### Example 1: Preparation of Composite Materials and Appearance Obtained

1—Preparation Method
Weighing a mass of xg of Matrix
   Example: 1000 g of PLA.
Weighing a mass of y g of RTF reinforcement, corresponding to n % of the matrix mass.
   Resuming the example: adding 20% RTF, i.e., 200 g of RTF per 1000 g of matrix.
Homogenization of the mixture by manual mixing.
Drying in the unventilated oven, 4 hours cycle at 80° C.
Extrusion-granulation of the matrix+RTF.
   Use of a single-screw extruder, diameter of the die 28 mm and length of the barrel 700 mm.
Cooling the rod in a water tank at ambient temperature.
Putting the rod into the bladed granulator.
Drying the pellets in a vacuum oven.
   Cycle: 20 minutes at 85° C., atmospheric pressure+20 minutes at 85° C., under vacuum.
Injection of the mixture into an Injection press.
   Steel mold at ambient T°, pressure and temperature according to the matrix/reinforcement pair.

A. Extrusion Shaping

The extrusion process is used to carry out the compounding of the mixture (polymer+RTF). The machine is equipped with a screw with a diameter of 35 mm and a length of 700 mm, which feeds a die 3 mm in diameter (L/D=20).

Extrusion Temperatures:
PLA: 170° C. at 180° C.
PP: 195° C.
PET: 230° C.

B. Injection Shaping

The injection of the impact test specimens was carried out simultaneously (mold with 2 cavities). The press used is a DK 50t.

General Usage Settings:
Maximum injection pressure: 150 bar
Injection stroke: 37 mm
Injection speed: 80 mm/s
Pressure hold time: 3 s at 60 bar
Cooling time: 30 s
Rotational speed of the screw: 266 rpm

Injection Temperatures According to Matrices:
PLA: 195° C.
PP: 195° C.
PET: 250° C.

In order to study the behavior of the composite material as a function of the fiber content introduced into the mixture, different mixtures at 15, 20 and 25% fibers were produced. The results are described below.

2—Description of the Materials Obtained by Extrusion
PET/recycled cotton textile fibers (RCTF) blends

As regards the 15% mixtures, extrusion was rather difficult to perform since cotton degrades from 195° C., whereas the PET extrusion temperature must be greater than 230° C. (melting point 255° C.). The extrusion of 20% and 25% of this mixture was not carried out with the difficulty encountered at 15% of RCTF. Even at low speed, the extruder was stopped and the rods had become very brittle.
PET/Recycled Synthetic Textile Fibers (RSTF) blends

The PET and RSTF mixture was also difficult to carry out since the temperature was necessarily too low for PET (Textrusion 230° C./Tm 255° C.). This temperature was chosen to preserve the polyamide fibers that degrade from 235° C. in the presence of oxygen. A very high pressure and several stoppages of the extruder were observed. It was nonetheless possible to produce rods with a proper texture.
PP/RSTF or RCTF blends

The extrusion of PP at 20 and 25% of RCTF and RSTF went quite well. It was necessary to adapt the extrusion temperature in order to obtain fewer brittle rods in order to be able to produce them continuously.
PLA/RSTF blend

Since PLA has a low melting point of 160 to 190° C., therefore its extrusion with the RSTF and RCTF has not posed any great difficulties. It was able to be extruded at 170° C. but above this temperature, degradation of the material was observable. The 15% mixture was not carried out.

Tests were also carried out with Recycled Blended Textile Fiber (RBTF) comprising 30% of synthetic fibers in the mixture and 70% decomposed cotton.

Regarding the appearance of the resulting composite materials: For all the mixtures, the extrusion operation has a tendency to properly homogenize the distribution of the fibers, thus the appearance is more regular and less innovative than the materials produced by direct injection of the fiber-matrix mixture that makes the textile fibers more visible. Generally, it is observed that the materials with cotton fibers have an appearance that is more irregular, compared to materials with synthetic fibers that exhibit a fairly homogeneous and dark appearance.

Conclusion: It has been observed that PET is not a good candidate to be the matrix of this type of composite material, as its high extrusion temperature degrades the fibers, which causes a dark color and makes the mixtures very problematic to produce.

PP is a material that is very easy to extrude, thus the mixtures were very easy to produce with this matrix. However, since PP is not very transparent, the appearance of these materials is clear.

PLA appeared to be an excellent material for this type of composite. As it is extruded at low temperature, the mixtures are very easy to produce continuously and the fibers are not degraded and retain their color.

### Example 2: Characterization of the Impact Strength of the Composite Materials

When recycling or blending polymers, the breaking strength and Young's modulus generally follow the parameters of the blends (even for immiscible polymers) and are hardly affected by the presence of impurities, thus the tensile test provides little relevant information on the quality of the mixture. Conversely, the impact breaking energy is heavily affected when the mixtures are immiscible or when one of the components has been degraded during extrusion or injection.

1. Methodology

The impact tests were carried out according to the standard set forth in ISO 179-1. The pendulum sheep is an XJF Edit-laser with a pendulum of terminal kinetic energy of 2 joules.

The test specimens were tested at least 24 hours after their injection. They were not notched. The calculated standard deviations are experimental standard deviations. These results are presented below. The produced test specimens (Charpy impact test specimen) correspond to the materials described in Example 1.

2. Characteristics of Unblended Polymer Matrices

The non-notched Charpy impact strength of pure PP is >50 kJ/m².

The non-notched Charpy impact strength of pure PLA is equal to 23 kJ/m².

The estimated non-notched Charpy impact strength of pure PET is >50 kJ/m² (given from the literature).

3. Characteristics of PP-Based Composite Matrices

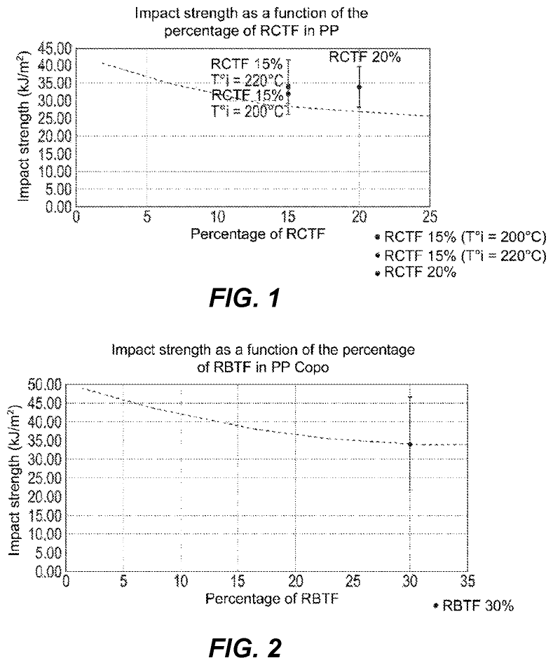

The results are presented in FIGS. 1, 2 and 3 relating respectively to the composite materials PP+RCTF, PP+RSTF and PP+RBTF.

Generally, the addition of textile fibers in the PP reduces the resilience of the polymer. This drop is quite marked for the synthetic fibers and is less felt with cotton fibers. The behavior becomes more fragile since the test specimens all broke in non-notched impact, which is not the case for PP alone. However, the impact strength remains quite good, 25 to 35 kJ/m² (close to PVC).

4. Characteristics of PLA-Based Composite Matrices

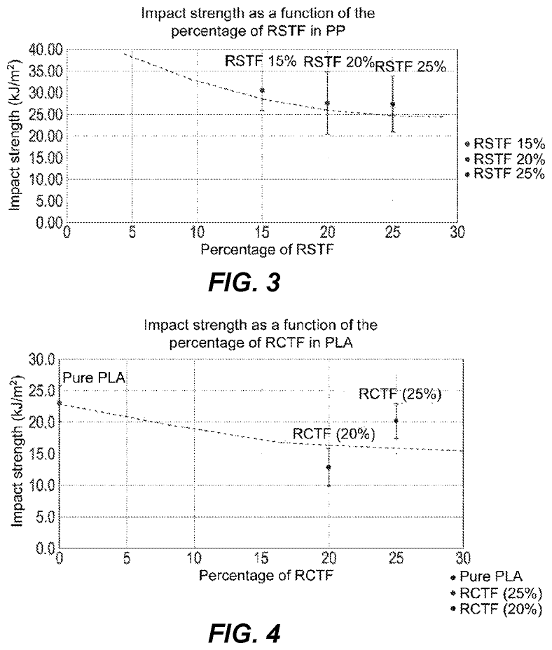

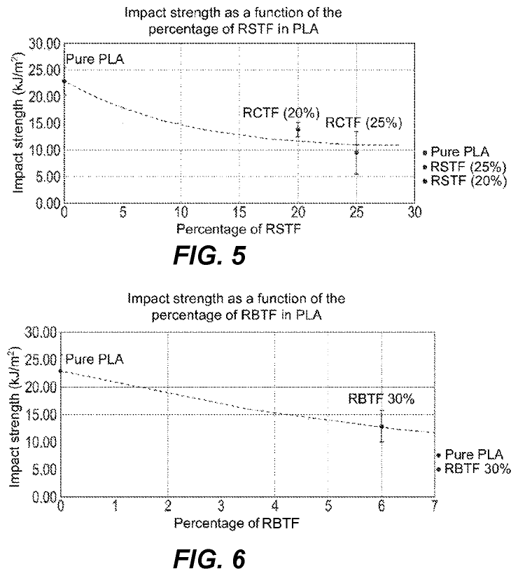

The results are presented in FIGS. 3, 4 and 5 relating respectively to the composite materials PLA+RCTF, PLA+RSTF and PLA+RBTF.

The addition of cotton fibers in the PLA causes the resilience of the polymer to drop very slightly, and in a manner that is much smaller than for PP. The drop is greater when the synthetic fibers are added. The break behavior is not modified. The impact strength remains as it should be: 10 to 20 kJ/m² (close to that of a non-impact PS), but this is normal, given that the PLA is not a very resilient material (23 kJ/m²).

5. Characteristics of PET-Based Composite Matrices

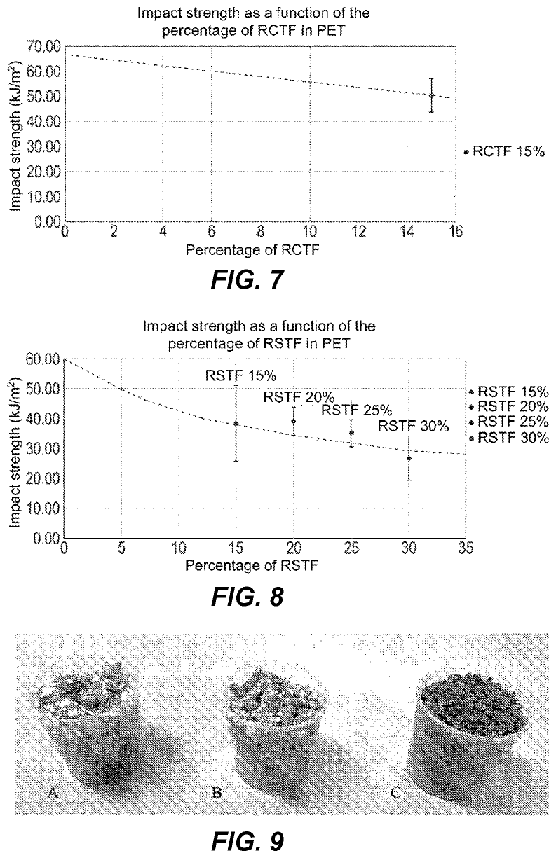

The results are presented in FIGS. 6 and 7 relating respectively to the composite materials PET+RCTF, and PP+RBTF.

As for PP, adding textile fibers to the PET reduces the resilience of the polymer. The behavior becomes more fragile since the test specimens all broke in non-notched impact, which is not the case for PET alone. However, the impact strength remains very advantageous: 28 to 50 kJ/m² (comparable to that of ABS).

Conclusion: Generally, the addition of recycled textile fibers reduces the resilience of the virgin polymer. This drop is especially marked for highly resilient polymers (PP, PET) whose ductile behavior becomes fragile, in fact the non-notched impact test becomes possible in the presence of textile fibers. It should be noted that quite good levels of resilience are obtained, which attests to a fairly good fiber/matrix affinity. To give orders of magnitude, the resilience of the PP loaded with recycled textile fibers is about 35 kJ/m², which is equivalent to a virgin PVC, the resilience of the PLA loaded with recycled textile fibers is about 10 to 15 kJ/m², which is equivalent to a virgin (non-impact) PS, the resilience of the PET loaded with recycled textile fibers is about 35 to 50 kJ/m², which is equivalent to a virgin (FR-loaded) ABS. It is interesting to note that the variation in the fiber content has little effect on resilience.

In all cases, a rather good fiber/matrix affinity is obtained, which leads to materials of good mechanical quality. The best resiliencies are obtained with cotton fibers.

### Example 3: Mechanical Characterization in Tension and Bending of Composite Materials

The objective of this study is to carry out monotonous uniaxial tensile tests, and 3-point bending tests on 3 polymer materials loaded with 15% to 25% of recycled natural fibers (cotton and synthetic): PLA, PP, PP COPO. The test specimens were obtained by injection. The tests were carried out according to the NF EN ISO 527-2 and NF EN ISO 178 standards at ambient temperature. Microscopic analyses of the fracture facies were carried out post-mortem using a scanning electron microscope.

1. Description of the Test Specimens Tested and Methodology

Type 1A test specimens according to the NF EN ISO 527-2 standard were used with a reference length L of 110 mm. The various materials tested are given below:
PLA+Cotton loaded at 25%
PLA+Synthetic loaded at 25%
PP+Cotton loaded at 15%
PP+Cotton loaded at 20%
PP+Synthetic loaded at 25%
PP COPO+Cotton loaded at 25%

The tensile and bending tests are carried out with an MTS-DY36 electro-mechanical tension/compression machine of capacity 100 kN.

The tensile tests are carried out in accordance with the NF EN ISO 527-2 standard. The samples are attached by spring clamping jaws. The movement of the cross-member is controlled by the control and acquisition PC of the machine. The force is measured using a 10 kN sensor (COFRAC-certified). The elongation of the test specimen is measured using a contact extensometer.

The bending tests are carried out in accordance with the NF EN ISO 178 standard. The samples are placed on two simple supports (span 40 mm). A circular punch with a radius of 6 mm presses on the center of the sample (FIG. 2). The movement of the cross-member is controlled by the control and acquisition PC of the machine. The force is measured using a 1 kN sensor (COFRAC-certified).

The microscopic observations are carried out using a ZEISS EVO HD 15 scanning electron microscope (SEM) (FIG. 4). The SEM is an instrument for investigating and assessment, making it possible quite particularly to examine the topography of the surfaces. This technique is mainly based on the detection of secondary electrons emerging from the surface under the impact of a very fine beam of primary electrons that scan the observed surface. It makes it possible to obtain images with very good resolution (up to 5 nm) and a large depth of field.

The mechanical characteristics such as the elastic modulus, maximum stress, or strain at break are estimated for each test piece from the stress/deformation curves and the geometric data of each test piece. The sections were estimated using a caliper. The curves presented below show the evolution of the stress as a function of the strain calculated from the corrected elongation of the curve base for a test specimen. The material parameters are estimated from these curves and summarized in the table below. The speed of travel of the cross-member has been defined as a function of the duration of the test. A quasi-static regime persists in all cases.

2. Results

The results are summarized in Table 1.

TABLE 1
Summary of the main results obtained from the tensile tests.

| | | PLA + | PLA + | | PP + | PP + | PP + | pp + |
|---|---|---|---|---|---|---|---|---|
| | Pure | Cotton | Synth | Pure | Cotton | Cotton | Synth | Cotton |
| | PLA | 25% | 25% | PP | 15% | 20% | 25% | 25% |
| Tensile | 3.1 ± 0.4 | 5.2 ± 0.7 | 3.8 ± 0.7 | 1.5 ± 0.4 | 2.2 ± 0.6 | 1.7 ± 0.3 | 1.7 ± 0.4 | 1.9 ± 0.4 |
| modulus | | | | | | | | |
| (GPa) | | | | | | | | |
| Yield | 58.4 ± 3.2 | 49 ± 3 | x | 14.0 ± 1.5 | 13.4 ± 1.1 | 11.6 ± 1.6 | 15 ± 2 | 14.2 ± 1.3 |
| strength | | | | | | | | |
| (MPa) | | | | | | | | |

Conclusion: The mechanical properties of composite materials are equivalent or greater than those of the equivalent virgin plastics. In particular, the addition of fibers significantly increases the tensile and bending moduli for PLA.

For PLA, and an equivalent fiber content, cotton has a better effect on the mechanical properties than the synthetic fibers.

For PP, there is no significant difference in the mechanical properties regardless of the content and the type of fibers.

The fiber/resin affinity is assumed to be good for cotton fibers, regardless of the resin, but the mechanical properties are more advantageous with PLA.

Synthetic fibers are assumed to have poor affinity with PLA and comparable affinity with cotton for PP. On the contrary, the synthetic fibers PLA test were all broken before the elastic limit was reached; this combination is therefore not recommended.

1. A method for manufacturing a composite material in the form of pellets from ground textile fibers and polymer in the form of resin grains, the method comprising:
densifying shreds of the textile fibers by compressing the material;
mixing the densified shreds with the polymer to form a mixture; and
mechanically heat treating the mixture at a temperature between temperatures T₁ T₂; wherein T₁ is the highest glass transition temperature between the polymer and that of the textile, whichever applies, and T₂ is the lowest melting point chosen between that of the polymer and that of the textile, whichever applies; and
wherein the mechanical heat treatment is implemented by extrusion and/or injection.

2. The method of claim 1, further comprising adding corn starch powder to the textile fibers before the densifying of the shreds of the textile fibers.

3. The method of claim 1, wherein the mechanical heat treatment is implemented by extrusion.

4. The method of claim 1, wherein the textile fibers comprise natural fibers, synthetic fibers or mixed fibers.

5. The method of claim 4, wherein the textile fibers are natural fibers and constitute up to 50% of the material.

6. The method of claim 4, wherein the textile fibers are synthetic fibers and constitute up to 90% of the material.

7. The method of claim 1, wherein the textile fibers are natural fibers and the polymer is polylactic acid.

8. The method of claim 7, wherein the natural fibers are cotton.

9. The method of claim 1, wherein the textile fibers are synthetic fibers and the polymer is polypropylene or high-density polyethylene.

10. A composite material comprising recycled textile fibers obtained by the method according to claim 1.

11. The composite material of claim 10, consisting essentially of natural fibers constituting up to 50% of the material and polylactic acid.

12. The composite material of claim 11, wherein the natural fibers are cotton fibers.

13. The composite material of claim 10, wherein the composite material consists essentially of synthetic fibers constituting up to 90% of the material and polypropylene or high-density polyethylene.

14. The composite material of claim 10, wherein the textile fibers comprise a blend of synthetic fibers and natural fibers, the blend constituting up to 70% of the material.

15. The composite material of claim 14, wherein the polymer is polypropylene or high-density polyethylene.
